(19) United States
(12) Patent Application Publication
(10) Pub. No.: US 2025/0250750 A1
(43) Pub. Date: Aug. 7, 2025

(54) AUTOMATED RAISED PAVEMENT MARKER PLACEMENT DEVICE

(71) Applicant: Vogel Traffic Services, Orange City, IA (US)

(72) Inventor: Jeffrey W Heldt, Sioux Center, IA (US)

(21) Appl. No.: 19/043,377

(22) Filed: Jan. 31, 2025

Related U.S. Application Data
(60) Provisional application No. 63/549,293, filed on Feb. 2, 2024.

(51) Int. Cl. E01C 23/18; B05C 1/08; B05C 5/02; B05C 9/12; E01F 9/512

(52) U.S. Cl. CPC E01C 23/18; B05C 1/0891; B05C 5/0225; B05C 9/12; E01F 9/512

(57) ABSTRACT

A system for automated pavement marker placement is disclosed, comprising a gun for applying a melted attachment substance onto a road surface, and a marker placement device for positioning a pavement marker onto the substance. The system includes one or more sensors to measure the speed of the gun and marker placement device, and processors to determine activation times for the gun and marker placement device based on speed and distance parameters. The described system addresses the technical problem of precise marker placement at varying speeds, providing a solution that ensures accurate alignment and adhesion of markers. The system is primarily used in road construction and maintenance, enhancing efficiency and accuracy in marker application. The processors dynamically adjust activation times in response to speed changes, optimizing the process for consistent results.

### RELATED APPLICATIONS

This application claims the benefit of U.S. Provisional Application No. 63/549,293, filed Feb. 2, 2024, the entire contents of which are incorporated herein by reference.

### TECHNICAL FIELD

The disclosure relates to systems to attach markers to roads and highways.

### BACKGROUND OF THE INVENTION

Many roads and highways are updating the ways in which the surfaces of those roads and highways are marked. For decades, the most basic marking of these surfaces has been painting lines on the roads to mark lanes for which cars should stay in. Newer technology includes placing reflectors on the paint, or even placing raised pavement markers onto the road that reduce the glare for oncoming traffic. However, the only way to place these markers is manually measuring, spacing, placing, and attaching the raised pavement markers.

### SUMMARY OF THE INVENTION

In general, the disclosure describes a system for automatically placing the raised pavement markers onto a surface without the need for manual interaction with the markers or the attachment substance. The system includes a melter to melt an attachment substance, such as bituminous, where the melted substance is then sent to a ribbon gun. The ribbon gun may be mounted on a moving vehicle, and the ribbon gun may be movable such that the system moves the ribbon gun down to near surface level to expel the melted attachment substance onto the surface. Markers may be loaded into the system and placed onto the melted attachment substance on the surface by a second movable part, such as a robotic arm. A sensor may be attached to the vehicle that measures a speed of the vehicle. Using the speed of the vehicle and the known distance between the ribbon gun and the marker placement device, a computer processor may set the timing of the placement of the melted attachment substance and the placement of the marker on the surface. Similarly, using the speed of the vehicle and a desired distance between markers, the computer processor may also set the timing between placements of the melted attachment substance on the surface such that the markers will be a set distance apart, aligning with local legal requirements.

In Example 1, the disclosure describes a system comprising: a gun configured to place a melted attachment substance onto a road surface; a marker placement device configured to place a pavement marker onto the melted attachment substance; one or more sensors configured to measure a speed at which the gun and the marker placement device are moving; and one or more processors configured to: determine a first time to activate the gun to place the melted attachment substance onto the road surface; determine, based on the speed and a distance between the gun and the marker placement device, a second time to activate the marker placement device such that the marker placement device placed the pavement marker onto the melted attachment substance placed by the gun; activate the gun at the first time; and activate the marker placement device at the second time.

Example 2 relates to the system of Example 1, wherein the gun comprises a thermoplastic ribbon gun equipped with a heating element to maintain the attachment substance at a specific temperature for application.

Example 3 relates to the system of Example 2, wherein the gun is mounted on a swinging parallel arm mechanism to adjust a position of the gun position in relation to the road surface.

Example 4 relates to the system of Example 1, wherein the marker placement device comprises a robotic arm equipped with a suction mechanism to hold and place the markers.

Example 5 relates to the system of Example 4, wherein the marker placement device includes a revolving parallel arm system.

Example 6 relates to the system of Example 5, wherein the marker placement device is equipped with a tensioned vertical slide to apply pressure on the marker for adhesion.

Example 7 relates to the system of Example 1, wherein the one or more sensors comprise a magnetic revolutions per minute (RPM) sensor integrated into a drivetrain of a vehicle containing the system for speed measurement.

Example 8 relates to the system of Example 7, wherein the one or more sensors include a GPS component to provide data for speed and location tracking.

Example 9 relates to the system of Example 1, wherein the one or more processors are configured to calculate the first time to activate the gun based on a predetermined formula that considers the speed.

Example 10 relates to the system of Example 9, wherein the one or more processors are configured to adjust subsequent calculations for times to activate the gun dynamically in response to determining the one or more sensors measure a change in the speed.

Example 11 relates to the system of Example 1, wherein the one or more processors are configured to calculate the second time to activate the marker placement device based on the speed, the distance between the gun and marker placement device, and a desired distance between markers.

Example 12 relates to the system of Example 11, wherein the one or more processors are further configured to adjust subsequent calculations for times to activate the marker placement device dynamically in response to determining the one or more sensors measure a change in the speed.

Example 13 relates to the system of Example 11, wherein the one or more processors are further configured to utilize a feedback loop to refine subsequent calculations for times to activate the marker placement device by comparing the actual placement of the marker with an intended placement.

Example 14 relates to the system of Example 1, wherein the one or more processors are configured to store historical speed data to optimize future calculations of subsequent times for activating the gun and marker placement device.

Example 15 relates to the system of Example 1, wherein the one or more processors are configured to: repeat determining subsequent times to activate the gun to place the melted attachment substance onto the road surface and to activate the marker placement device to place the pavement marker onto the melted attachment substance placed by the gun; and activate the gun and the marker placement device at the respective subsequent times.

Example 16 relates to the system of Example 1, wherein the one or more processors are configured to determine the first time by based on a first user input activating the gun.

In Example 17, the disclosure includes a method comprising: controlling, by one or more processors, one or more sensors configured to measure a speed at which a gun and a marker placement device are moving, wherein the gun is configured to place a melted attachment substance onto a road surface, and wherein the marker placement device is configured to place a pavement marker onto the melted attachment substance; determining, by the one or more processors, a first time to activate the gun to place the melted attachment substance onto the road surface; determining, by the one or more processors, and based on the speed and a distance between the gun and the marker placement device, a second time to activate the marker placement device such that the marker placement device placed the pavement marker onto the melted attachment substance placed by the gun; activating, by the one or more processors, the gun at the first time; and activating, by the one or more processors, the marker placement device at the second time.

Example 18 relates to the method of Example 17, wherein determining the second time to activate the marker placement device is based on the speed, the distance between the gun and marker placement device, and a desired distance between markers, wherein the method further comprises adjusting, by the one or more processors, subsequent calculations for times to activate the marker placement device dynamically in response to determining the one or more sensors measure a change in the speed.

In Example 19, the disclosure includes a non-transitory computer-readable storage medium comprising instructions that, when executed by one or more processors of a computing device, cause the computing device to: control one or more sensors configured to measure a speed at which a gun and a marker placement device are moving, wherein the gun is configured to place a melted attachment substance onto a road surface, and wherein the marker placement device is configured to place a pavement marker onto the melted attachment substance; determine a first time to activate the gun to place the melted attachment substance onto the road surface; determine, based on the speed and a distance between the gun and the marker placement device, a second time to activate the marker placement device such that the marker placement device placed the pavement marker onto the melted attachment substance placed by the gun; activate the gun at the first time; and activate the marker placement device at the second time.

Example 20 relates to the non-transitory computer-readable storage medium of Example 19, wherein determining the second time to activate the marker placement device is based on the speed, the distance between the gun and marker placement device, and a desired distance between markers, wherein the instructions, when executed, further cause the one or more processors to adjust subsequent calculations for times to activate the marker placement device dynamically in response to determining the one or more sensors measure a change in the speed.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

The following drawings are illustrative of particular examples of the present disclosure and therefore do not limit the scope of the invention. The drawings are not necessarily to scale, though examples can include the scale illustrated, and are intended for use in conjunction with the explanations in the following detailed description wherein like reference characters denote like elements. Examples of the present disclosure will hereinafter be described in conjunction with the appended drawings.

FIG. 1 is a side view of a ribbon gun and marker placement device mounted on a vehicle, in accordance with one or more of the techniques described herein.

FIG. 2 is a block diagram illustrating a more detailed example of a computing device configured to perform the techniques described herein.

FIG. 3 is side view of the ribbon gun of FIG. 1 placing the melted attachment substance on a road surface, in accordance with one or more of the techniques described herein.

FIG. 4 is a side view of the marker placement device of FIG. 1 placing the raised pavement marker on the melted attachment substance placed from FIG. 3, in accordance with one or more of the techniques described herein.

FIG. 5 is a side view of the system from FIG. 4 after the raised pavement marker has been placed on the melted attachment substance where the marker placement device is reloaded, in accordance with one or more of the techniques described herein.

FIG. 6 is a schematic view of the marker placement device and a parts list, in accordance with one or more of the techniques described herein.

FIG. 7 is another schematic view of the marker placement device, in accordance with one or more of the techniques described herein.

FIG. 8 is another schematic view of the marker placement device, in accordance with one or more of the techniques described herein.

### DETAILED DESCRIPTION

The following detailed description is exemplary in nature and is not intended to limit the scope, applicability, or configuration of the techniques or systems described herein in any way. Rather, the following description provides some practical illustrations for implementing examples of the techniques or systems described herein. Those skilled in the art will recognize that many of the noted examples have a variety of suitable alternatives.

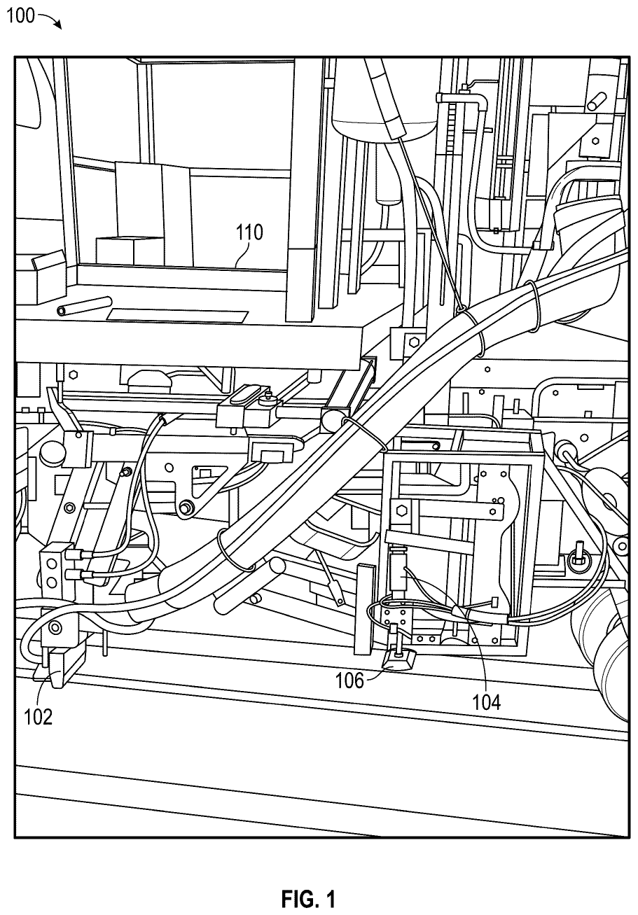

FIG. 1 is a side view of an automatic raised pavement marker placement system 100 with ribbon gun 102 and marker placement device 104 mounted on a vehicle 110, in accordance with one or more of the techniques described herein. The automatic raised pavement marker placement system 100 is a revolving parallel-arm device (e.g., marker placement device 104) electronically speed adjusted to place markers at zero-velocity at vehicle speeds greater than 0 mph based on, but not limited to, speed input from a magnetic driveline sensor.

Bituminous (or any other attachment substance) is heated in a melter, sent through a material pump at the outlet of the melter to a thermoplastic ribbon gun (e.g., ribbon gun 102). The ribbon gun may be mounted on a swinging parallel arm system operated by a hydraulic cylinder to approximate ¾ road speed. In some instances, the total swing motion is 12 linear inches rearward in the time the vehicle moves 16 linear inches forward, to achieve 4″ of forward gun movement over the duration of 16 inches of vehicle travel. However, other configurations may allow for different distances for the swing motion and vehicle motion, and timing and distance calculations are adjusted as necessary based on the arrangement of devices on the vehicle and the vehicle's speed. This operation allows for up to four times more time for the gun to release the necessary volume of material for proper adhesion than a static mounted gun.

For the purposes of this disclosure, while described as a ribbon gun, ribbon gun 102 may be any device capable of placing an adhesive strip down on pavement from a moving vehicle such that, when a raised pavement marker is pressed down on top of the adhesive, the raised pavement marker is adhered to the pavement in a durable manner for effective use in marking traffic on said pavement. This includes, for instance, profile guns or other similar technologies.

The marker operation is controlled electronically to match road speed on a revolving parallel arm system (e.g., marker placement device 104). Markers (e.g., marker 106) are stored in a 4-marker staging cartridge on a carriage that houses motors and provides static height from the ground for the revolving parallel arm. Markers are delivered to the staging cartridge via slide chute from a cartridge-style carousel mounted above it (on the deck, in this case, to be expanded upon later in this summary). Operational sequence for applying a marker involves signals being sent via programmable logic controller to a motor to actuate a slide tray at the bottom of the carriage, delivering a single marker for the suction foot to pick up. Air cylinder activates to pick up the marker via vacuum within a suction cup and upon achieving a threshold vacuum, air cylinder retracts. Drive motor prepares the marker to be placed, and using adjustable offsets within the timing system, the marker is placed directly into the adhesive at zero velocity. The revolving arm returns to a home position to prepare the next marker. The foot mechanism by which the marker is placed is mounted on a tensioned vertical slide to provide downward force on the marker into the adhesive for positive adhesion and also allows for placing on uneven surfaces found on many roads.

A software program may be written in to the system that has a timing mechanism for calculating when to activate ribbon gun 102 and marker placement device 104 based on speeds and arrangements of the devices. A magnetic RPM sensor may be placed in a drivetrain of vehicle 110 to be able to measure speed. The software program may take this speed as input and, with input for how many inches separate the ribbon gun and the marker placement device, determine when to activate each device such that the markers are a particular distance apart and such that the marker is placed on the previously placed melted attachment substance. The distance between the markers can vary based on jurisdiction or preference, although this distance is usually 40, 80, or 120 feet.

In accordance with the techniques for this disclosure, system 100 may include gun 102 configured to place a melted attachment substance onto a road surface. System 100 may also include marker placement device 104 configured to place pavement marker 106 onto the melted attachment substance. System 100 may also include one or more sensors configured to measure a speed at which gun 102 and marker placement device 104 are moving. System 100 may further include one or more processors configured to determine a first time to activate gun 102 to place the melted attachment substance onto the road surface and determine, based on the speed and a distance between the gun and the marker placement device, a second time to activate marker placement device 104 such that marker placement device 104 places the pavement marker onto the melted attachment substance placed by the gun. The one or more processors may activate gun 102 at the first time and may activate marker placement device 104 at the second time. System 100's integration of gun 102, marker placement device 104, sensors, and processors enables automated and precise placement of pavement markers. This reduces manual labor, increases accuracy, and ensures consistent marker spacing, enhancing road safety and efficiency.

In some instances, gun 102 may be a thermoplastic ribbon gun (or similar profile gun) equipped with a heating element to maintain the attachment substance at a specific temperature for application. The thermoplastic ribbon gun with a heating element maintains the attachment substance at an optimal temperature, ensuring proper adhesion and durability of the markers, even in varying environmental conditions. Furthermore, in some instances, gun 102 may be mounted on a swinging parallel arm mechanism to adjust a position of gun 102 position in relation to the road surface. The swinging parallel arm mechanism allows for precise positioning of the gun relative to the road surface, accommodating different road contours and improving the accuracy of substance application.

In some instances, marker placement device 104 may be a robotic arm equipped with a suction mechanism to hold and place the markers. The robotic arm with a suction mechanism securely holds and places markers, minimizing the risk of misplacement and ensuring consistent application, which enhances the reliability of the road marking process. Furthermore, in some instances, marker placement device 104 may include a revolving parallel arm system to ensure placement at varying vehicle speeds. The revolving parallel arm system in the marker placement device adapts to varying vehicle speeds, ensuring accurate marker placement regardless of speed fluctuations, thus maintaining consistent marker spacing. Marker placement device 104 may, additionally or alternatively, be equipped with a tensioned vertical slide to apply pressure on the marker for adhesion. The tensioned vertical slide applies consistent pressure on the marker, ensuring optimal adhesion to the road surface, which enhances the longevity and effectiveness of the markers.

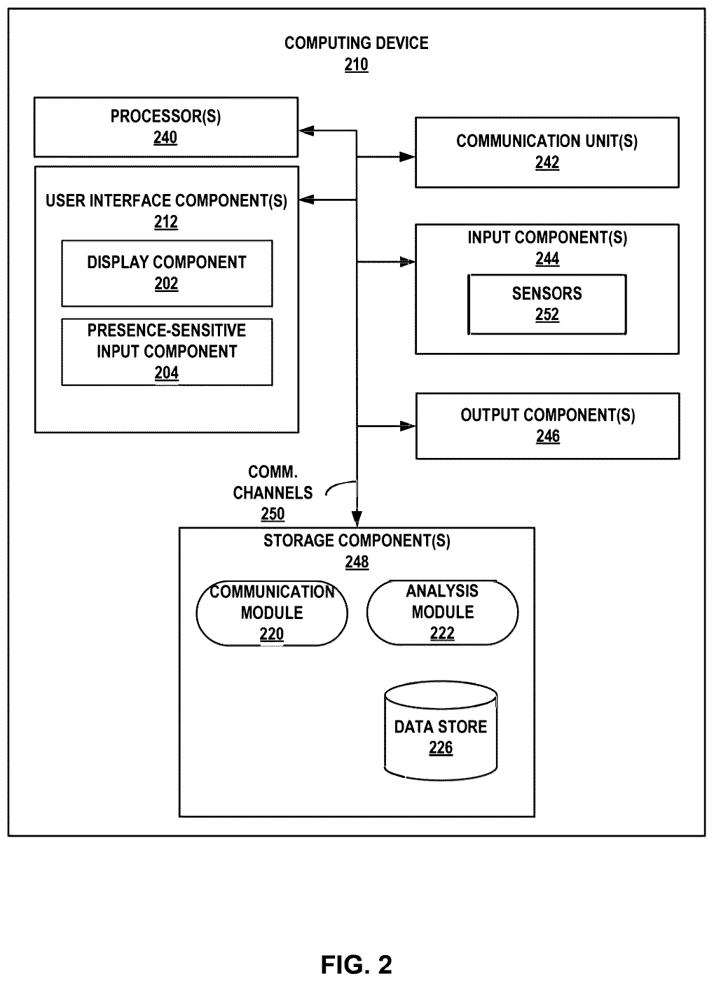

In some instances, the one or more sensors (e.g., sensors 252 of FIG. 2) may include a magnetic revolutions per minute (RPM) sensor integrated into a drivetrain of a vehicle containing the system for speed measurement. The magnetic RPM sensor integrated into vehicle 110's drivetrain provides accurate speed measurements, enabling precise timing calculations for the activation of the gun and marker placement device. Additionally or alternatively, the one or more sensors may include a GPS component to provide data for speed and location tracking. The inclusion of a GPS component in the group of one or more sensors provides additional data for speed and location tracking, enhancing the system's ability to adjust to varying road conditions and ensuring accurate marker placement.

The marking of roads and highways has traditionally relied on painting lines to delineate lanes, guiding vehicles safely along their paths. This method, while effective, often lacks durability and visibility, especially under adverse weather conditions. In recent years, advancements have introduced the use of reflectors and raised pavement markers to enhance visibility and reduce glare for oncoming traffic. These markers provide a more robust solution, offering better performance in low-light and wet conditions. However, the process of placing these markers remains labor-intensive, requiring manual measurement, spacing, and attachment, which can be time-consuming and prone to human error.

Current methods for placing raised pavement markers involve manual labor, which presents several disadvantages. The manual process is not only labor-intensive but also inefficient, as frequent stops are required to measure and place each marker accurately. This can lead to inconsistencies in spacing and alignment, potentially compromising the effectiveness of the markers. Additionally, manual placement can pose safety risks to workers, who operate in close proximity to moving traffic. The reliance on human precision also increases the likelihood of errors, which can result in markers being improperly adhered or misaligned, reducing their effectiveness and lifespan.

The present system addresses these challenges by introducing a method for automatically placing raised pavement markers onto road surfaces without manual intervention. This method includes a melter to prepare an attachment substance, such as bituminous material, which is then applied to the road surface using a ribbon gun or a profile gun mounted on a moving vehicle. The gun is designed to be adjustable, allowing the gun to move close to the surface for precise application. A marker placement device, such as a robotic arm, is used to position the markers onto the melted attachment substance. The system is equipped with sensors to measure the vehicle's speed, enabling a processor to calculate the optimal timing for both the application of the attachment substance and the placement of the markers. This automation ensures consistent spacing and alignment, improving the efficiency and safety of the marker placement process.

The techniques and systems described herein are for automatically placing pavement markers on a road surface, which includes a gun for applying a melted attachment substance, a marker placement device, a sensor for measuring speed, and processors for timing the activation of the gun and marker placement device. This arrangement allows for precise and efficient placement of pavement markers without manual intervention. The system's components are physically integrated to ensure that the melted attachment substance is applied at the correct location and time, followed by the placement of the marker, which adheres to the substance. The techniques further include automated coordination between the gun and marker placement device, which may be dynamically adjusted based on the vehicle's speed and the distance between the gun and the marker placement device. This automation translates into a practical application by reducing the need for manual labor, increasing the accuracy of marker placement, and ensuring compliance with legal spacing requirements. The system's capability to adjust in real-time to changes in speed enhances the system's adaptability to varying road conditions, providing a reliable solution for road marking.

The system described herein provides a number of benefits. The driver is able to stay in constant motion, not requiring a stop at each marker location. Markers and bituminous can be loaded to system constantly meaning once the truck starts rolling it can go until the materials on the deck are used up without requiring operator interaction. Bituminous application and marker application may be designed to match road speed. The system may apply the marker at or near zero velocity means better placement and adhesion to the road surface, closely mimicking the current method of hand placement that has proven effective. Position identification may cause the marker to agitate into adhesive material on road surface, providing superior adhesion.

FIG. 2 is a block diagram illustrating a more detailed example of a computing device configured to perform the techniques described herein. FIG. 2 illustrates only one particular example of computing device 210, and many other examples of computing device 210 may be used in other instances and may include a subset of the components included in example computing device 210 or may include additional components not shown in FIG. 2.

Computing device 210 may be any computer with the processing power required to adequately execute the techniques described herein. For instance, computing device 210 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), a vehicle, a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein. Additionally computing device 210 may be any integrated device, such as one or more processors implemented into a vehicle or a system (e.g., vehicle 110 of FIG. 1 or system 100 of FIG. 1) where the processors control various devices in the system in accordance with readings from a sensor.

As shown in the example of FIG. 2, computing device 210 includes user interface components (UIC) 212, one or more processors 240, one or more communication units 242, one or more input components 244, one or more output components 246, and one or more storage components 248. UIC 212 includes display component 202 and presence-sensitive input component 204. Storage components 248 of computing device 210 include communication module 220, analysis module 222, and data store 226.

One or more processors 240 may implement functionality and/or execute instructions associated with computing device 210 to determine timing for placing attachment substances and pavement markers on a road surface and control the devices that place those materials on the road surface. That is, processors 240 may implement functionality and/or execute instructions associated with computing device 210 to automatically place raised pavement markers on a road surface.

Examples of processors 240 include any combination of application processors, display controllers, auxiliary processors, one or more sensor hubs, and any other hardware configured to function as a processor, a processing unit, or a processing device, including dedicated graphical processing units (GPUs). Modules 220 and 222 may be operable by processors 240 to perform various actions, operations, or functions of computing device 210. For example, processors 240 of computing device 210 may retrieve and execute instructions stored by storage components 248 that cause processors 240 to perform the operations described with respect to modules 220 and 222. The instructions, when executed by processors 240, may cause computing device 210 to determine timing for placing attachment substances and pavement markers on a road surface and control the devices that place those materials on the road surface.

Communication module 220 may execute locally (e.g., at processors 240) to provide functions associated with receiving data from a sensor and controlling devices in the automatic raised pavement marker system to place attachment substances and pavement markers. In some examples, communication module 220 may act as an interface to a remote service accessible to computing device 210. For example, communication module 220 may be an interface or application programming interface (API) to a remote server that receives data from a sensor and controls devices in the automatic raised pavement marker system to place attachment substances and pavement markers.

In some examples, analysis module 222 may execute locally (e.g., at processors 240) to provide functions associated with calculating timing for when to activate the various placement devices in an automatic raised pavement marker system. In some examples, analysis module 222 may act as an interface to a remote service accessible to computing device 210. For example, analysis module 222 may be an interface or application programming interface (API) to a remote server that calculates timing for when to activate the various placement devices in an automatic raised pavement marker system.

One or more storage components 248 within computing device 210 may store information for processing during operation of computing device 210 (e.g., computing device 210 may store data accessed by modules 220 and 222 during execution at computing device 210). In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220 and 222 and data store 226. Storage components 248 may include a memory configured to store data or other information associated with modules 220 and 222 and data store 226.

Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices via one or more wired and/or wireless networks by transmitting and/or receiving network signals on one or more networks. Examples of communication units 242 include a network interface card (e.g., such as an Ethernet card), an optical transceiver, a radio frequency transceiver, a GPS receiver, a radio-frequency identification (RFID) transceiver, a near-field communication (NFC) transceiver, or any other type of device that can send and/or receive information. Other examples of communication units 242 may include short wave radios, cellular data radios, wireless network radios, as well as universal serial bus (USB) controllers.

One or more input components 244 of computing device 210 may receive input. Examples of input are tactile, audio, and video input. Input components 244 of computing device 210, in one example, include a presence-sensitive input device (e.g., a touch sensitive screen, a PSD), mouse, keyboard, voice responsive system, camera, microphone or any other type of device for detecting input from a human or machine. In some examples, input components 244 may include one or more sensor components (e.g., sensors 252). Sensors 252 may include one or more biometric sensors (e.g., fingerprint sensors, retina scanners, vocal input sensors/microphones, facial recognition sensors, cameras), one or more location sensors (e.g., GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a radar sensor, a lidar sensor, a sonar sensor, a heart rate sensor, magnetometer, glucose sensor, olfactory sensor, compass sensor, or a step counter sensor.

One or more output components 246 of computing device 210 may generate output in a selected modality. Examples of modalities may include a tactile notification, audible notification, visual notification, machine generated voice notification, or other modalities. Output components 246 of computing device 210, in one example, include a presence-sensitive display, a sound card, a video graphics adapter card, a speaker, a cathode ray tube (CRT) monitor, a liquid crystal display (LCD), a light emitting diode (LED) display, an organic LED (OLED) display, a virtual/augmented/extended reality (VR/AR/XR) system, a three-dimensional display, or any other type of device for generating output to a human or machine in a selected modality.

UIC 212 of computing device 210 may include display component 202 and presence-sensitive input component 204. Display component 202 may be a screen, such as any of the displays or systems described with respect to output components 246, at which information (e.g., a visual indication) is displayed by UIC 212 while presence-sensitive input component 204 may detect an object at and/or near display component 202.

While illustrated as an internal component of computing device 210, UIC 212 may also represent an external component that shares a data path with computing device 210 for transmitting and/or receiving input and output. For instance, in one example, UIC 212 represents a built-in component of computing device 210 located within and physically connected to the external packaging of computing device 210 (e.g., a screen on a mobile phone). In another example, UIC 212 represents an external component of computing device 210 located outside and physically separated from the packaging or housing of computing device 210 (e.g., a monitor, a projector, etc. that shares a wired and/or wireless data path with computing device 210).

UIC 212 of computing device 210 may detect two-dimensional and/or three-dimensional gestures as input from a user of computing device 210. For instance, a sensor of UIC 212 may detect a user's movement (e.g., moving a hand, an arm, a pen, a stylus, a tactile object, etc.) within a threshold distance of the sensor of UIC 212. UIC 212 may determine a two or three-dimensional vector representation of the movement and correlate the vector representation to a gesture input (e.g., a hand-wave, a pinch, a clap, a pen stroke, etc.) that has multiple dimensions. In other words, UIC 212 can detect a multi-dimension gesture without requiring the user to gesture at or near a screen or surface at which UIC 212 outputs information for display. Instead, UIC 212 can detect a multi-dimensional gesture performed at or near a sensor which may or may not be located near the screen or surface at which UIC 212 outputs information for display.

In accordance with the techniques of this disclosure, communication module 220 may receive data from sensors 252, such as a magnetic revolution sensor, GPS, or other speed sensor that measures a speed of a vehicle on which the automatic raised pavement marker placement system is mounted. Based on this speed, analysis module 222 may determine when to activate a ribbon gun to place a melted attachment substance (e.g., bituminous, tar, or any other substance that can reasonably attach a raised pavement marker safely to a road surface). Also based on this speed and a known distance between the ribbon gun and a marker placement device, analysis module 222 may determine when to activate the marker placement device such that the marker placement device places the marker on the previously placed melted attachment substance. Communication module 220 may output the signals to control each of the ribbon gun and the marker placement device at the proper times, as calculated by analysis module 222. This process may repeat based on a desired spacing between the road markers, which can either be input into the system or preprogrammed into the system.

The system's integration of a gun, marker placement device, sensors 252, and computing device 210 enables automated and precise placement of pavement markers. This reduces manual labor, increases accuracy, and ensures consistent marker spacing, enhancing road safety and efficiency.

In some instances, analysis module 222 may calculate the first time to activate the gun based on a predetermined formula that considers the speed. Analysis module 222 may calculate the first time to activate the gun using a predetermined formula that considers speed and, in some instances, even substance viscosity, ensuring optimal application timing and substance adhesion. In some further instances, analysis module 222 may adjust subsequent calculations for times to activate the gun dynamically in response to determining the one or more sensors measure a change in the speed. The dynamic adjustment of the first time calculation in response to speed changes ensures that the application of the attachment substance remains accurate and consistent, even with vehicle speed variations.

In some examples, analysis module 222 may calculate the second time to activate the marker placement device based on the speed, the distance between the gun and marker placement device, and a desired distance between markers. The processors calculate the second time to activate the marker placement device based on speed and distance parameters, ensuring that markers are placed precisely on the melted attachment substance. In some such instances, analysis module 222 may adjust subsequent calculations for times to activate the marker placement device dynamically in response to determining the one or more sensors measure a change in the speed. This allows for real-time adjustments to the timing mechanism to ensure that proper placement is maintained even with changes in speed. Additionally or alternatively, analysis module 222 may utilize a feedback loop to refine subsequent calculations for times to activate the marker placement device by comparing the actual placement of the marker with an intended placement. The feedback loop refines the second time calculation by comparing actual and intended marker placements, improving the accuracy and reliability of the marker placement process.

In some instances, communication module 220 may store historical speed data to optimize future calculations of subsequent times for activating the gun and marker placement device. Storing historical speed data allows the system to optimize future timing calculations, enhancing the efficiency and accuracy of marker placement over time.

In some instances, analysis module 222 may repeat determining subsequent times to activate the gun to place the melted attachment substance onto the road surface and to activate the marker placement device to place the pavement marker onto the melted attachment substance placed by the gun. Communication module 220 may activate the gun and the marker placement device at the respective subsequent times. The system's ability to repeat the determination of subsequent activation times ensures continuous and consistent marker placement, improving the overall efficiency of the road marking process.

In some instances, analysis module 222 may determine the first time by based on receiving a first user input activating the gun. Allowing user input to determine the first time for gun activation provides flexibility and adaptability, enabling customization of the marker placement process to meet specific requirements or preferences.

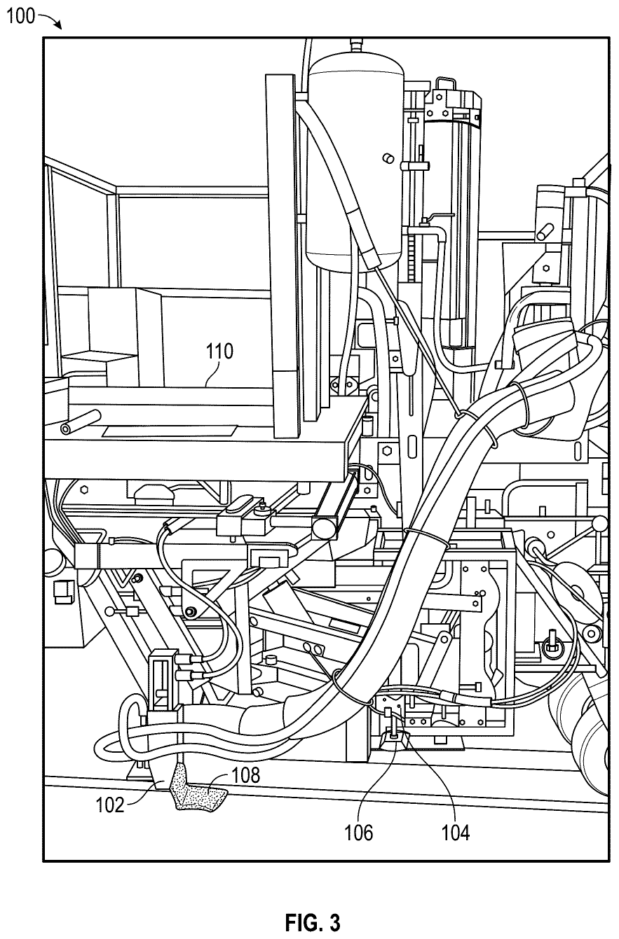

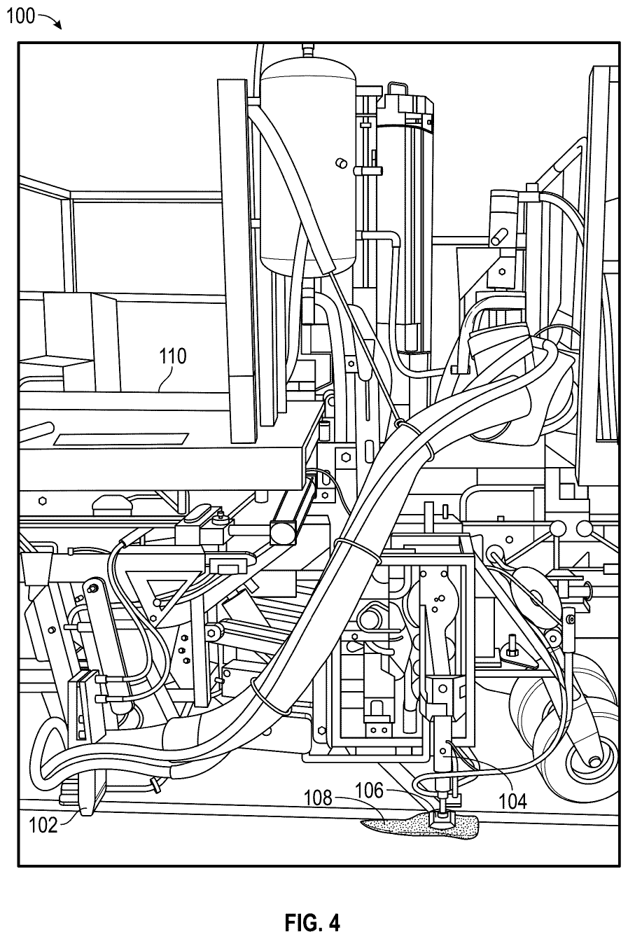

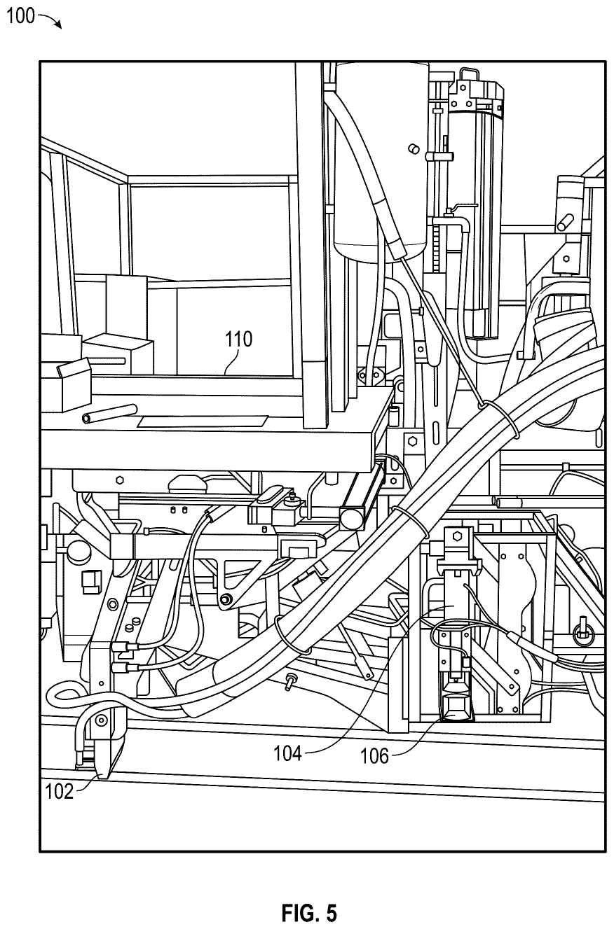

FIG. 3 is side view of the ribbon gun 102 of FIG. 1 placing the melted attachment substance 108 on a road surface, in accordance with one or more of the techniques described herein. FIG. 4 is a side view of the marker placement device 104 of FIG. 1 placing the raised pavement marker 106 on the melted attachment substance 108 placed from FIG. 3, in accordance with one or more of the techniques described herein. FIG. 5 is a side view of the system 100 from FIG. 4 after the raised pavement marker has been placed on the melted attachment substance, in accordance with one or more of the techniques described herein. In FIG. 5, marker placement device 104 is reloading to grab a second raised pavement marker 106, enabling the process to repeat.

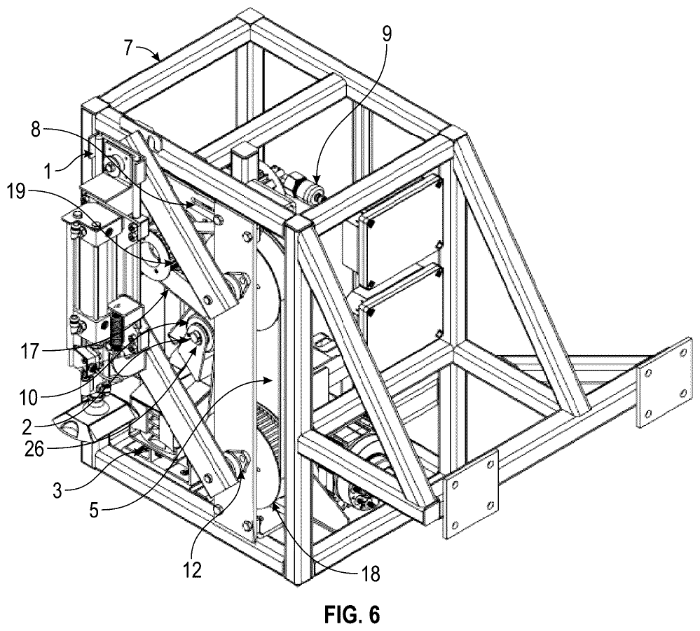

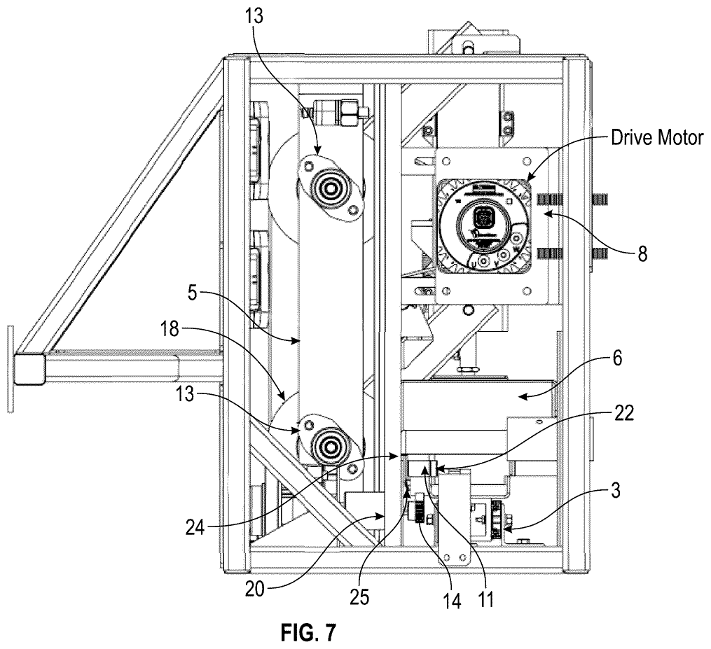

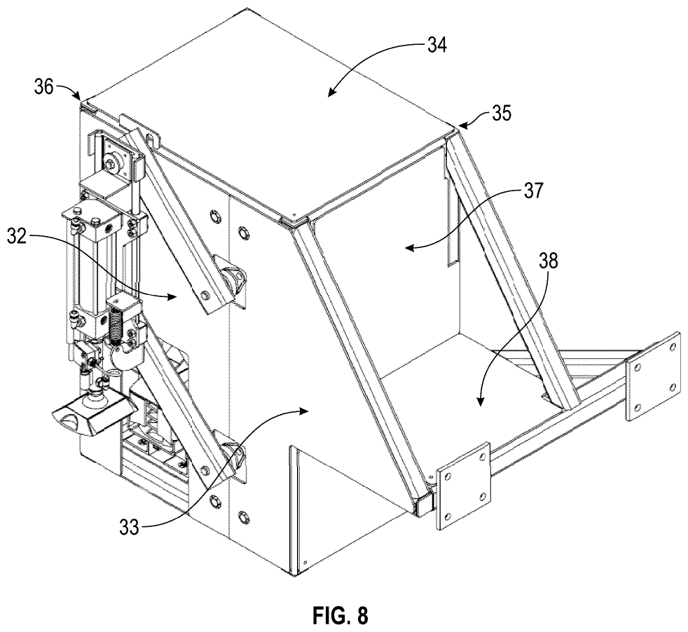

FIGS. 6-8 are schematic views of the marker placement device and a parts list, in accordance with one or more of the techniques described herein. The parts depicted in FIGS. 6-8 are listed below as examples, although other arrangements and other parts could be utilized, as any device capable of placing a raised pavement marker from a higher position down onto a surface at a controlled time may be utilized in the systems described herein.

In the schematics of FIGS. 6-8, the parts include for this example include:
full arm assembly 1
roller wheel pin 2
tray assembly 3
narrow slide tray gear shaft 4
belt bearing mount 5
delivery mag weldment 6
CRG cage frame weldment 7
drive motor mount weldment 8
vacuum transducer 9
cam follower bearing 10
nylon sleeve bearing 11
dry running mounted sleeve 12
low profile ball bearing 13
tray drive gear 14
quick disconnect bushing 15
quick disconnect bushing 16
timing belt 17
timing belt pulley 18
timing belt pulley 19
keyed shaft 20
hex bolt 21
shoulder bolt 22
hex nut 23
hex nut 24
washer 25
pin cotter 26
keystock 27
keystock 28
end slide 29
slide tray proximity sensor mount 30
arm homing proximity sensor mount 31
side panel 32
side panel 33
top panel 34
side panel 35
front panel 36
rear panel 37
component mount panel 38

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

It is contemplated that the various aspects, features, processes, and operations from the various embodiments may be used in any of the other embodiments unless expressly stated to the contrary. Certain operations illustrated may be implemented by a computer executing a computer program product on a non-transient, computer-readable storage medium, where the computer program product includes instructions causing the computer to execute one or more of the operations, or to issue commands to other devices to execute one or more operations.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as a pre-configured, stand-alone hardware element and/or as preprogrammed hardware elements (e.g., application specific integrated circuits, FPGAs, and digital signal processors), or other related components.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

While the various systems described above are separate implementations, any of the individual components, mechanisms, or devices, and related features and functionality, within the various system embodiments described in detail above can be incorporated into any of the other system embodiments herein.

The terms “about” and “substantially,” as used herein, refers to variation that can occur (including in numerical quantity or structure), for example, through typical measuring techniques and equipment, with respect to any quantifiable variable, including, but not limited to, mass, volume, time, distance, wave length, frequency, voltage, current, and electromagnetic field. Further, there is certain inadvertent error and variation in the real world that is likely through differences in the manufacture, source, or precision of the components used to make the various components or carry out the methods and the like. The terms “about” and “substantially” also encompass these variations. The term “about” and “substantially” can include any variation of 5% or 10%, or any amount—including any integer—between 0% and 10%. Further, whether or not modified by the term “about” or “substantially,” the claims include equivalents to the quantities or amounts.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾. This applies regardless of the breadth of the range. Although the various embodiments have been described with reference to preferred implementations, persons skilled in the art will recognize that changes may be made in form and detail without departing from the spirit and scope thereof.

Various examples of the disclosure have been described. Any combination of the described systems, operations, or functions is contemplated. These and other examples are within the scope of the following claims.

1. A system comprising:
a gun configured to place a melted attachment substance onto a road surface;
a marker placement device configured to place a pavement marker onto the melted attachment substance;
one or more sensors configured to measure a speed at which the gun and the marker placement device are moving; and
one or more processors configured to:
determine a first time to activate the gun to place the melted attachment substance onto the road surface;
determine, based on the speed and a distance between the gun and the marker placement device, a second time to activate the marker placement device such that the marker placement device placed the pavement marker onto the melted attachment substance placed by the gun;
activate the gun at the first time; and
activate the marker placement device at the second time.

2. The system of claim 1, wherein the gun comprises a thermoplastic ribbon gun equipped with a heating element to maintain the attachment substance at a specific temperature for application.

3. The system of claim 2, wherein the gun is mounted on a swinging parallel arm mechanism to adjust a position of the gun position in relation to the road surface.

4. The system of claim 1, wherein the marker placement device comprises a robotic arm equipped with a suction mechanism to hold and place the markers.

5. The system of claim 4, wherein the marker placement device includes a revolving parallel arm system.

6. The system of claim 5, wherein the marker placement device is equipped with a tensioned vertical slide to apply pressure on the marker for adhesion.

7. The system of claim 1, wherein the one or more sensors comprise a magnetic revolutions per minute (RPM) sensor integrated into a drivetrain of a vehicle containing the system for speed measurement.

8. The system of claim 7, wherein the one or more sensors include a GPS component to provide data for speed and location tracking.

9. The system of claim 1, wherein the one or more processors are configured to calculate the first time to activate the gun based on a predetermined formula that considers the speed.

10. The system of claim 9, wherein the one or more processors are configured to adjust subsequent calculations for times to activate the gun dynamically in response to determining the one or more sensors measure a change in the speed.

11. The system of claim 1, wherein the one or more processors are configured to calculate the second time to activate the marker placement device based on the speed, the distance between the gun and marker placement device, and a desired distance between markers.

12. The system of claim 11, wherein the one or more processors are further configured to adjust subsequent calculations for times to activate the marker placement device dynamically in response to determining the one or more sensors measure a change in the speed.

13. The system of claim 11, wherein the one or more processors are further configured to utilize a feedback loop to refine subsequent calculations for times to activate the marker placement device by comparing the actual placement of the marker with an intended placement.

14. The system of claim 1, wherein the one or more processors are configured to store historical speed data to optimize future calculations of subsequent times for activating the gun and marker placement device.

15. The system of claim 1, wherein the one or more processors are configured to:
repeat determining subsequent times to activate the gun to place the melted attachment substance onto the road surface and to activate the marker placement device to place the pavement marker onto the melted attachment substance placed by the gun; and
activate the gun and the marker placement device at the respective subsequent times.

16. The system of claim 1, wherein the one or more processors are configured to determine the first time by based on a first user input activating the gun.

17. A method comprising:
controlling, by one or more processors, one or more sensors configured to measure a speed at which a gun and a marker placement device are moving, wherein the gun is configured to place a melted attachment substance onto a road surface, and wherein the marker placement device is configured to place a pavement marker onto the melted attachment substance;
determining, by the one or more processors, a first time to activate the gun to place the melted attachment substance onto the road surface;
determining, by the one or more processors, and based on the speed and a distance between the gun and the marker placement device, a second time to activate the marker placement device such that the marker placement device placed the pavement marker onto the melted attachment substance placed by the gun;
activating, by the one or more processors, the gun at the first time; and
activating, by the one or more processors, the marker placement device at the second time.

18. The method of claim 17, wherein determining the second time to activate the marker placement device is based on the speed, the distance between the gun and marker placement device, and a desired distance between markers,
wherein the method further comprises adjusting, by the one or more processors, subsequent calculations for times to activate the marker placement device dynamically in response to determining the one or more sensors measure a change in the speed.

19. A non-transitory computer-readable storage medium comprising instructions that, when executed by one or more processors of a computing device, cause the computing device to:
control one or more sensors configured to measure a speed at which a gun and a marker placement device are moving, wherein the gun is configured to place a melted attachment substance onto a road surface, and wherein the marker placement device is configured to place a pavement marker onto the melted attachment substance;
determine a first time to activate the gun to place the melted attachment substance onto the road surface;
determine, based on the speed and a distance between the gun and the marker placement device, a second time to activate the marker placement device such that the marker placement device placed the pavement marker onto the melted attachment substance placed by the gun;
activate the gun at the first time; and
activate the marker placement device at the second time.

20. The non-transitory computer-readable storage medium of claim 19, wherein determining the second time to activate the marker placement device is based on the speed, the distance between the gun and marker placement device, and a desired distance between markers,
wherein the instructions, when executed, further cause the one or more processors to adjust subsequent calculations for times to activate the marker placement device dynamically in response to determining the one or more sensors measure a change in the speed.
